(19) United States
(12) Patent Application Publication
(10) Pub. No.: US 2017/0235338 A1
(43) Pub. Date: Aug. 17, 2017

(54) ELECTRONIC DEVICE WITH INTERCHANGEABILITY AND MODULARITY

(71) Applicant: INTEL CORPORATION, Santa Clara, CA (US)

(72) Inventors: Hong W. Wong, Portland, OR (US); Wah Yiu Kwong, Hillsboro, OR (US); Cheong W. Wong, Beaverton, OR (US); Xiaoguo Liang, Shanghai (CN); Christine Kim, Costa Mesa, CA (US)

(73) Assignee: INTEL CORPORATION, Santa Clara, CA (US)

(21) Appl. No.: 15/503,100

(22) PCT Filed: Sep. 26, 2014
(86) PCT No.: PCT/CN2014/087509

§ 371 Date: Feb. 10, 2017

(51) Int. Cl. G06F 1/16; A45C 11/00; A45C 15/00; A45C 1/06

(52) U.S. Cl. CPC G06F 1/1626; A45C 1/06; A45C 11/00; A45C 15/00; G06F 1/1652; G06F 1/1656; A45C 2011/002; A45C 2011/003

(57) ABSTRACT

An electronic device is described herein. The electronic device includes a portable housing for the electronic device. A zipper of the portable housing is to enable access to the electronic device. Additionally, the electronic device includes a flexible display integrated into the portable housing. The zipper may enable electromagnetic interference (EMI) shielding while enclosing the electronic device and associated components within the portable form factor. In embodiments, a flexible magnetic seal may be used to enclose the electronic device and associated components within the portable form factor.

### TECHNICAL FIELD

The present techniques relate generally to electronic devices within small form factors. More specifically, the present techniques relate generally to a personal computer (PC) with a small form factor that enables accessibility, modularity, and interchangeability of components.

### BACKGROUND ART

Electronic devices with generally small form factors include pocket PCs, tablets, smart phones, and the like. Frequently, these devices are limited to a particular use case and form factor. In particular, components of these electronic devices with small form factors are linked to a form factor without any modularity. Components of the electronic devices are typically not interchangeable and lack widespread accessibility.

### BRIEF DESCRIPTION OF THE DRAWINGS

FIG. 1 is a block diagram of a personal computer (PC) with a small form factor that enables accessibility, modularity, and interchangeability of components;

FIG. 2 is an illustration of a personal computer that incorporates features of a wallet, with a zipper to house electronic components;

FIG. 3 is an illustration of a wallet without an integrated zipper; and

FIG. 4 is a process flow diagram of a method for enabling a small form factor that includes a modular and interchangeable PC ingredients or components.

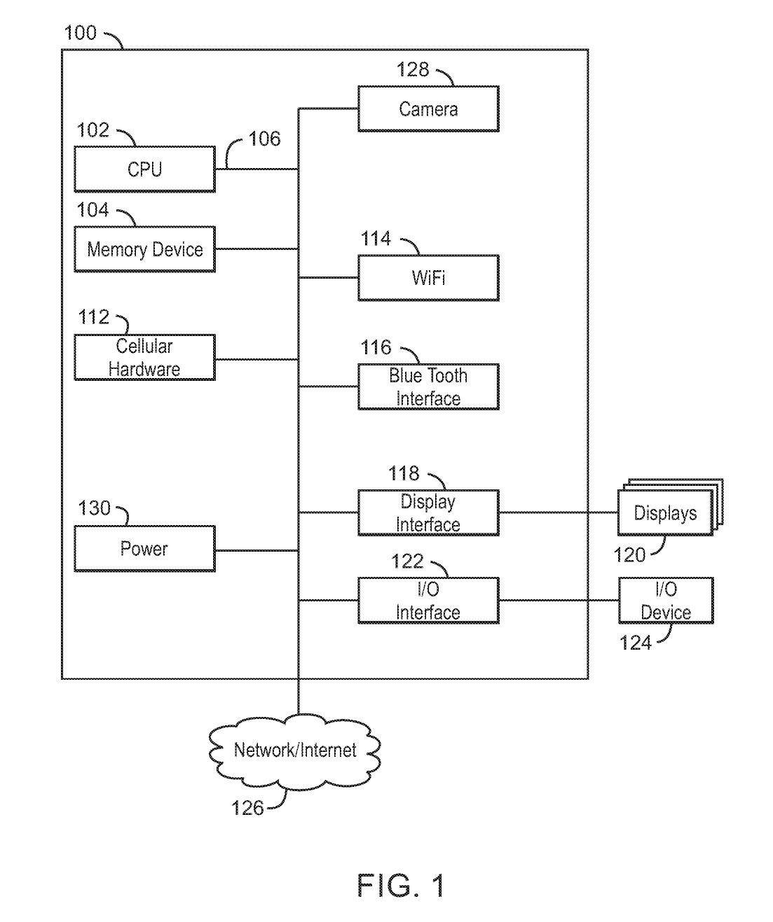

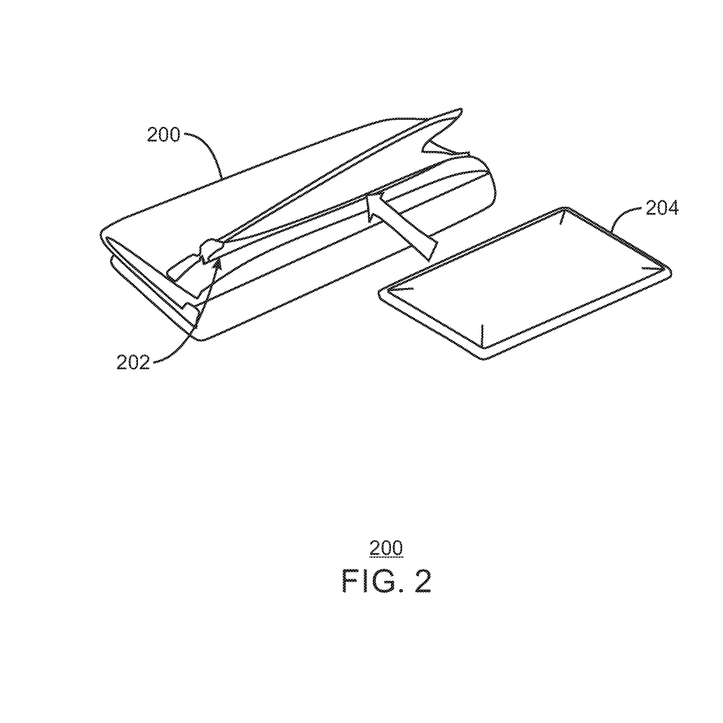

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

As discussed above, the majority of electronic devices with small form factors are limited to a particular use case and form factor. This results in a product that can be limited with respect to widespread application. Moreover, as current electronic device products come in a number of small form factors, such as of watches, ear pierces, glasses, or activity bands, these form factors may be ill suited for interchangeability across other form factors. Furthermore, current wearable electronic devices are not modular. Rather, these devices are permanently linked to the original form factor.

Embodiments described herein generally relate to a personal computer (PC) with a small form factor that enables accessibility, modularity, and interchangeability of components. In embodiments, the small form factor is a wallet PC. The wallet PC includes interchangeable electric components. In some cases, the wallet PC is a modular PC. In embodiments, the small form factor includes a flexible display that is foldable. Further, in some embodiments, the small form factor includes a modular and interchangeable power source.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

FIG. 1 is a block diagram of a personal computer (PC) 100 with a small form factor that enables accessibility, modularity, and interchangeability of components. The PC 100 may be enclosed within any wearable or portable form factor. For example, the PC 100 can be combined with a wallet form factor to enable a wallet PC. In another example, the PC 100 is enclosed within a wearable form factor such as a purse, tote, checkbook, day planner, agenda, or a form of apparel.

The PC 100 includes a central processing unit (CPU) 102 that is configured to execute stored instructions, as well as a memory device 104 that stores instructions that are executable by the CPU 102. The CPU may be coupled to the memory device 104 by a bus 106. Additionally, the CPU 102 can be a single core processor, a multi-core processor, a computing cluster, or any number of other configurations. Furthermore, the PC 100 may include more than one CPU 102.

The memory device 104 can include random access memory (RAM), read only memory (ROM), flash memory, or any other suitable memory systems. For example, the memory device 104 may include dynamic random access memory (DRAM). In some cases, the PC 100 includes an image capture mechanism, such as a camera 128. The CPU 102 may be linked through the bus 106 to cellular hardware 112. The cellular hardware 112 may be any cellular technology, for example, the 4G standard (International Mobile Telecommunications-Advanced (IMT-Advanced) Standard promulgated by the International Telecommunications Union-Radio communication Sector (ITU-R)). In this manner, the PC 100 may access any network 126 without being tethered or paired to another device, where the network 126 is a cellular network.

The CPU 102 may also be linked through the bus 106 to WiFi hardware 114. The WiFi hardware is hardware according to WiFi standards (standards promulgated as Institute of Electrical and Electronics Engineers' (IEEE) 802.11 standards). The WiFi hardware enables the PC 100 to connect to the Internet using the Transmission Control Protocol and the Internet Protocol (TCP/IP), where the network 126 is the Internet. Accordingly, the PC 100 can enable end-to-end connectivity with the Internet by addressing, routing, transmitting, and receiving data according to the TCP/IP protocol without the use of another device. Additionally, a Bluetooth Interface 116 may be coupled to the CPU 102 through the bus 106. The Bluetooth Interface 116 is an interface according to Bluetooth networks (based on the Bluetooth standard promulgated by the Bluetooth Special Interest Group). The Bluetooth Interface 116 enables the PC 100 to be paired with other Bluetooth enabled devices through a personal area network (PAN). Accordingly, the network 126 may be a PAN. Examples of Bluetooth enabled devices include a laptop computer, desktop computer, ultrabook, tablet computer, mobile device, or server, among others.

The CPU 102 may be linked through the bus 106 to a display interface 118 configured to connect the PC 100 to a plurality of displays 120. The displays 120 may include a display screen that is a built-in component of the PC 100. The displays 120 may be a number of flexible, foldable displays. In some cases, the foldable displays are a component of the wearable form factor that is to be combined with the PC 100. For example, a wallet may include a flexible, foldable display that is coupled with the display interface 118 and the PC 100 via a mini-backplane present within the wallet. Additionally, in some cases, the display device 120 may also be a computer monitor, television, or projector, among others, that is externally connected to the PC 100. The CPU 102 may also be connected through the bus 106 to an input/output (I/O) device interface 122 configured to connect the PC 100 to one or more I/O devices 124. The I/O devices 124 may include, for example, a pointing device or a touch screen, among others. The I/O devices 124 may be built-in components of the PC 100. Additionally, the PC 100 may also include an image capture mechanism or camera 128 The camera 128 may be used to capture images to be rendered on the displays 120.

The components of the PC 100 may be a single module, such as a system-on-chip (SOC), or the components of the PC 100 can be individual modular components. Specifically, each of the CPU 102, memory device 104, cellular hardware 112, camera 128, WiFi 114, Bluetooth Interface 116, display interface 118, I/O interface 122, and power 130 can be individual components that are coupled via hardware present in the wearable or portable form factor. For example, a wallet form factor may include a mini-backplane and other electrical connectors that can be used to couple the modular components into a wallet PC. As discussed above, the wallet form factor may also include a flexible, foldable display that can be coupled with modular components via a mini-backplane and other electrical connectors in the wallet form factor. Moreover, the modular components can be interchangeable across wearable or portable form factors. For example, the components of the PC 100 can be used in a wallet form factor, or inserted into a purse form factor. Further, in embodiments, the components of the PC 100 can be used with a wearable form factor, such as apparel or an armband. The PC may also include fitness components, such as a pedometer or heart rate monitor. As used herein, a fitness component can be any component or module used to measure health parameters of a user, such as activity levels, various bodily functions, and sleep.

The power 130 may supply power to other components of the PC 100 via a connection to a mini-backplane. In some embodiments, wireless power may occur. The power 130 may be a battery. The battery may be an individual modular component of the PC 100. In this manner, the battery can be easily changed as necessary. In embodiments, the power 130 may be a battery that is integrated into another modular component of the PC, such as the CPU 102, memory device 104, cellular hardware 112, camera 128, WiFi 114, Bluetooth Interface 116, display interface 118, or the I/O interface 122.

The block diagram of FIG. 1 is not intended to indicate that the PC 100 is to include all of the components shown in FIG. 1. Further, the PC 100 may include any number of additional components not shown in FIG. 1, depending on the details of the specific implementation. The components of the PC 100 can be individual, modular components that are interchangeable in a small form factor.

FIG. 2 is an illustration of a personal computer that looks like a wallet 200 with a zipper 202. Accordingly, the wallet 200 houses a personal computer and additional components of a personal computer. As illustrated, the wallet 200 also houses a flexible battery 204. Although not illustrated, a display device may be integrated into the wallet 200. In some cases, one display may be located on the interior of the wallet 200, with another display located on the exterior of the wallet 200. Accordingly, the wallet 200 may include a plurality of displays. The displays may be a light-emitting diode (LED), organic light-emitting diode (OLED), flexible OLED, thin-film-transistor liquid-crystal display (TFT LCD), electronic paper, or any other flexible, thin display technology. The battery 204 may be a flexible battery, such as a flexible print circuit (FPC) lithium ceramic battery (FLCB). Although a battery is illustrated, other components can be included in addition to, or in place of the battery 204. For example, the battery 204 can also be other components, such as solid state storage device, adaptor coil module for wireless charging or a subscriber identification module (SIM).

The zipper 202 of the wallet 200 may be made of a metal material in order to mitigate radio frequency interference, also known as electromagnetic interference (EMI). Thus, the zipper can enable EMI shielding. In some cases, the zipper can be positioned to open and close the wallet as well as enable EMI shielding. Although one zipper is illustrated, the wallet 200 may include several zippers and compartments to accommodate an interchangeable, modular PC, such as the PC 100 (FIG. 1).

The wallet can be made of various materials, including but not limited to fabric, leather, synthetic leather, or plastic. These materials can form the exterior, or skin, of the wallet. The skin of the wallet can be used to create a tight Faraday cage surrounding components of the PC. In embodiments, the wallet 200 may include a number of Faraday cages that can block electrical fields from components of the PC. The Faraday cages can also be created using materials in addition to the skin of the wallet. For example, the wallet may also include an inner flexible metal layer within the skin of the wallet that can create a Faraday cage. Additionally, a coated conductive layer on an underside of the skin can be used to create a tight Faraday cage. Faraday cages can also be created on the components themselves. In particular, each component of the PC can be surrounded by a material to prevent EMI. For example, each component of the PC can be wrapped by foil or another metallic material.

To conduct or dissipate heat within the wearable or portable form factor, the wearable or portable form factor may also include a metallic conductive layer, heat conduction fabric, or graphite sheet on or within the skin. In examples, the wallet 200 includes a metallic conductive layer, heat conduction fabric, or graphite sheet that is to conduct or dissipate heat. Additionally, the wallet 200 includes edge connectors to enable docking of the each component of the PC to the wallet's mini backplane or other electrical connectors. In embodiments, each modular component can be locked into place by an edge connector. The locking mechanism may include a push-to-lock design.

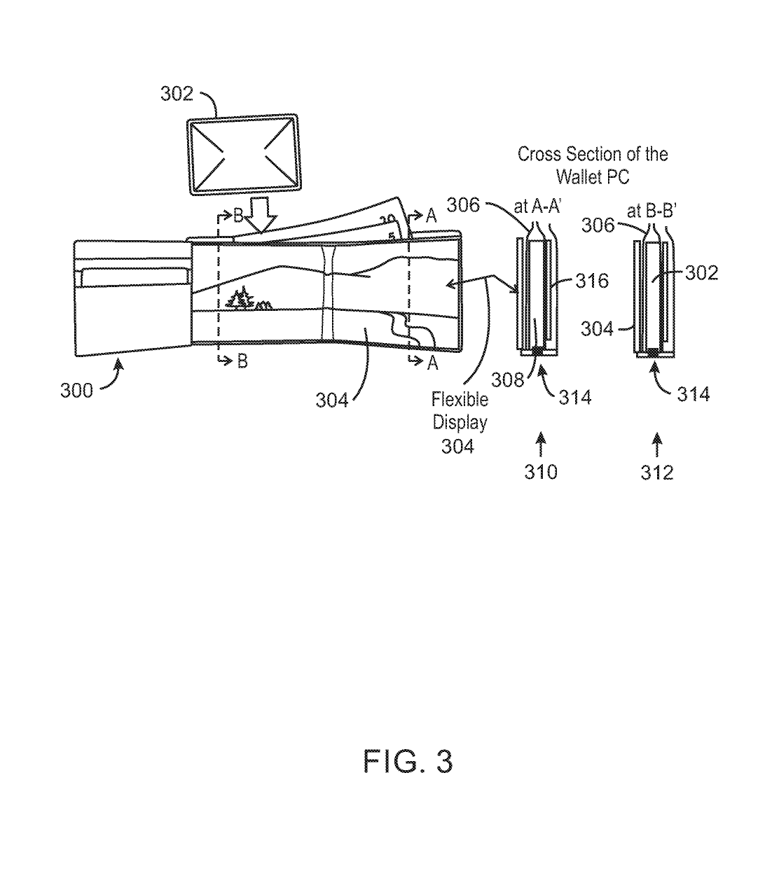

FIG. 3 is an illustration of a wallet 300 without an integrated zipper. A battery 302 may be inserted in to pockets of the wallet 300. The wallet 300 may also include a flexible, foldable display 304. The display 304 may have a bending radius between 12-15 mm. The display may be a light-emitting diode (LED), organic light-emitting diode (OLED), flexible OLED, thin-film-transistor liquid-crystal display (TFT LCD), electronic paper, or any other flexible, thin display technology. Although a single display is illustrated, the wallet 300 may include any number of displays.

The wallet 300 includes a modular interchangeable PC component that can be inserted into the wallet in a manner similar to the battery 302. A cross section of the wallet 300 from A-A′ is illustrated at reference number 310. The cross section 310 shows a flexible display 304 with the wallet skin 306 surrounding a processor module 308. The pocket of skin 306 surrounding the processor module 308 can be closed by a magnetically sealed opening that is to enable EMI shielding and is to secure the skin around the components. In examples, the processor module 308 is a PC 100 (FIG. 1) as discussed above. As illustrated, the processor module 308 is coupled with a backplane connector 314 that extends along the length of the wallet 300. Typical wallet contents, such as the money 316, are located within another pocket created by the skin 306 of the wallet 300.

Another cross section of the wallet 300 from B-B′ after insertion of the battery 302 is illustrated at reference number 312. The cross section 312 shows a flexible display 304 with the wallet skin 306 surrounding the battery 302. The pocket of skin 306 surrounding the battery 302 can also be closed by a magnetically sealed opening that is to enable EMI shielding and is to secure the skin around the components. In some cases, the battery is a flexible battery, such as an FLCB. As illustrated, the battery 302 is coupled with a backplane connector 314 that extends along the length of the wallet 300. Typical wallet contents, such as the money 316, are located within another pocket created by the skin 306 of the wallet 300.

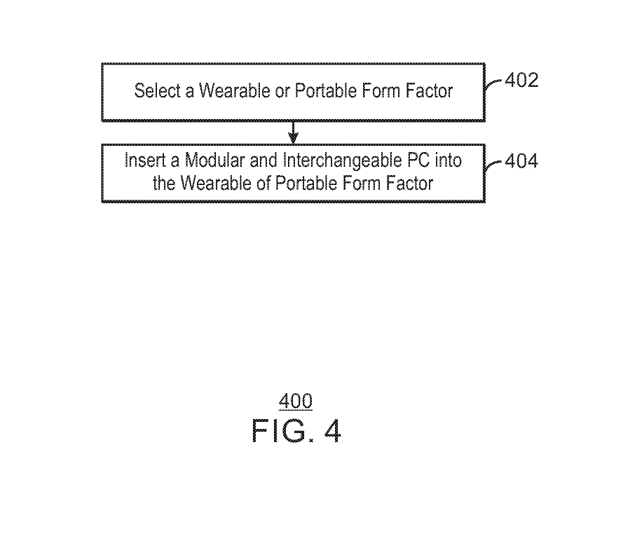

FIG. 4 is a process flow diagram of a method 400 for enabling a small form factor that includes a modular and interchangeable PC. At block 402, a wearable or portable form factor is selected. At block 404, a PC is inserted into the wearable or portable form factor, where the PC includes components that are modular and can be interchanged.

### EXAMPLE 1

An electronic device is described herein. The electronic device includes a portable housing for the electronic device. A zipper of the portable housing is to enable access to the electronic device. The electronic device also includes a flexible display integrated into the portable housing.

The zipper may enable electromagnetic interference (EMI) shielding. The zipper may be formed from a metallic material that enables electromagnetic interference (EMI) shielding. Additionally, the zipper may create a pocket of the portable housing that forms a Faraday cage. The pocket of the portable housing may be formed by a flexible metal layer in a skin of the portable housing. The pocket of the portable housing may be formed by a coated conductive layer on a portion of a skin of the portable housing. The portable housing may comprise a metallic conductive layer, heat conduction fabric, graphite sheet, or any combination thereof, that is to dissipate heat. The portable housing may comprises a plurality of zippers. Moreover, the plurality of zippers may form a plurality of pockets of the portable housing. The portable housing may be a wallet.

### EXAMPLE 2

An electronic device is described herein. The electronic device includes a portable housing for the electronic device. A pocket of the portable housing is to enable access to the electronic device. The electronic device also includes a flexible display integrated into the portable housing.

The pocket may be sealed via magnetic strips. Additionally, the pocket may enable electromagnetic interference (EMI) shielding. The pocket of the portable housing may form a Faraday cage from a material used to construct the portable housing. The pocket of the portable housing may be formed by a flexible metal layer in a skin of the portable housing. The pocket of the portable housing may be formed by a coated conductive layer on a portion of a skin of the portable housing. The portable housing may include a metallic conductive layer, heat conduction fabric, graphite sheet, or any combination thereof, that is to dissipate heat. The portable housing may comprise a plurality of pockets that are to be sealed by magnetic strips. Also, the portable housing may include a mini-backplane to dock components of the electronic device. The mini-backplane may be flexible.

### EXAMPLE 3

A method for enabling a small form factor that includes a modular and interchangeable personal computer (PC) is described herein. The method includes selecting a portable form factor, and inserting the modular and interchangeable personal computer into the portable form factor.

The portable form factor may be a wallet, purse, tote, checkbook, day planner, agenda, form of apparel, or any combination thereof. The portable form factor may also be a wearable form factor. The modular and interchangeable personal computer may be interchanged between a wallet, purse, tote, checkbook, day planner, agenda, form of apparel, or any combination thereof. A zipper of the portable form factor may enable electromagnetic interference (EMI) shielding. A magnetically sealed pocket of the portable form factor may enable electromagnetic interference (EMI) shielding. Further, a flexible display may be integrated into the portable housing. The modular and interchangeable personal computer may be inserted into a pocket of the portable form factor. The pocket may create a Faraday cage. The modular and interchangeable personal computer may be surrounded by a metallic coating to enable EMI shielding.

### EXAMPLE 4

An apparatus is described herein. The apparatus includes a means to enclose an electronic device, wherein a zipper of the means is to enable access to the electronic device. The apparatus also includes a flexible display integrated into the means to enclose the electronic device.

The zipper may enable electromagnetic interference (EMI) shielding. The zipper may be formed from a metallic material that enables electromagnetic interference (EMI) shielding. Further, the zipper may create a pocket within the means to enclose the electronic device that forms a Faraday cage. The pocket of the means to enclose the electronic device may be formed by a flexible metal layer in a skin of the means to enclose the electronic device. The pocket of the means to enclose the electronic device may be formed by a coated conductive layer on a portion of a skin of the means to enclose the electronic device. The means to enclose the electronic device may include a metallic conductive layer, heat conduction fabric, graphite sheet, or any combination thereof, that is to dissipate heat. The means to enclose the electronic device may include a plurality of zippers. The plurality of zippers may form a plurality of pockets of the means to enclose the electronic device. Also, the means to enclose the electronic device may be a wallet.

### EXAMPLE 5

An apparatus is described herein. The apparatus includes a means to enclose an electronic device, wherein a pocket of the means to enclose the electronic device is to enable access to the electronic device. The apparatus also includes a flexible display integrated into the means to enclose the electronic device.

The pocket may be sealed via magnetic strips. The pocket may enable electromagnetic interference (EMI) shielding. Additionally, the pocket of the means to enclose the electronic device may form a Faraday cage from a material used to construct the means to enclose the electronic device. The pocket of the means to enclose the electronic device may be formed by a flexible metal layer in a skin of the means to enclose the electronic device. The pocket of the means to enclose the electronic device maybe formed by a coated conductive layer on a portion of a skin of the means to enclose the electronic device. Additionally, the means to enclose the electronic device may include a metallic conductive layer, heat conduction fabric, graphite sheet, or any combination thereof, that is to dissipate heat. Additionally, the means to enclose the electronic device may include a plurality of pockets that are to be sealed by magnetic strips. Also, the means to enclose the electronic device may include a mini-backplane to dock components of the electronic device. The mini-backplane may be flexible.

It is to be understood that specifics in the aforementioned examples may be used anywhere in one or more embodiments. For instance, all optional features of the electronic device described above may also be implemented with respect to either of the methods or the computer-readable medium described herein. Furthermore, although flow diagrams and/or state diagrams may have been used herein to describe embodiments, the present techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

1-25. (canceled)

26. An electronic device, comprising:
a portable housing for the electronic device, wherein a zipper of the portable housing is to enable access to the electronic device; and
a flexible display integrated into the portable housing.

27. The electronic device of claim 26, wherein the zipper is to enable electromagnetic interference (EMI) shielding.

28. The electronic device of claim 26, wherein the zipper is formed from a metallic material that enables electromagnetic interference (EMI) shielding.

29. The electronic device of claim 26, wherein the zipper creates a pocket of the portable housing that forms a Faraday cage.

30. The electronic device of claim 26, wherein the zipper creates a pocket of the portable housing that forms a Faraday cage, and the pocket of the portable housing is formed by a flexible metal layer in a skin of the portable housing.

31. The electronic device of claim 26, wherein the zipper creates a pocket of the portable housing that forms a Faraday cage, and the pocket of the portable housing is formed by a coated conductive layer on a portion of a skin of the portable housing.

32. The electronic device of claim 26, wherein the portable housing comprises a metallic conductive layer, heat conduction fabric, graphite sheet, or any combination thereof, that is to dissipate heat.

33. The electronic device of claim 26, wherein the portable housing comprises a plurality of zippers that form a plurality of pockets of the portable housing.

34. The electronic device of claim 26, wherein the portable housing is a wallet.

35. An electronic device, comprising:
a portable housing for the electronic device, wherein a pocket of the portable housing is to enable access to the electronic device; and
a flexible display integrated into the portable housing.

36. The electronic device of claim 35, wherein the pocket is to be sealed via magnetic strips.

37. The electronic device of claim 35, wherein the pocket is to enable electromagnetic interference (EMI) shielding.

38. The electronic device of claim 35, wherein the pocket of the portable housing forms a Faraday cage from a material used to construct the portable housing.

39. The electronic device of claim 35, wherein the pocket of the portable housing is formed by a flexible metal layer in a skin of the portable housing.

40. The electronic device of claim 35, wherein the pocket of the portable housing is formed by a coated conductive layer on a portion of a skin of the portable housing.

41. The electronic device of claim 35, wherein the portable housing comprises a metallic conductive layer, heat conduction fabric, graphite sheet, or any combination thereof, that is to dissipate heat.

42. The electronic device of claim 35, wherein the portable housing comprises a plurality of pockets that are to be sealed by magnetic strips.

43. The electronic device of claim 35, wherein the portable housing includes a mini-backplane to dock components of the electronic device, and the mini-backplane is flexible.

44. A method for enabling a small form factor that includes a modular and interchangeable personal computer (PC), comprising:
selecting a portable form factor; and
inserting the modular and interchangeable personal computer into the portable form factor.

45. The method of claim 44, wherein the portable form factor is a wallet, purse, tote, checkbook, day planner, agenda, form of apparel, or any combination thereof.

46. The method of claim 44, wherein the portable form factor is a wearable form factor.

47. The method of claim 44, wherein the modular and interchangeable personal computer is interchanged between a wallet, purse, tote, checkbook, day planner, agenda, form of apparel, or any combination thereof.

48. The method of claim 44, wherein a zipper of the portable form factor is to enable electromagnetic interference (EMI) shielding.

49. The method of claim 44, wherein a magnetically sealed pocket of the portable form factor is to enable electromagnetic interference (EMI) shielding.

50. The method of claim 44, wherein a flexible display is integrated into the portable housing.
